(19) United States
(12) Patent Application Publication
(10) Pub. No.: US 2010/0102549 A1
(43) Pub. Date: Apr. 29, 2010

(54) GROOVED TRANSITION COUPLING

(76) Inventor: Joseph G. Radzik, Warwick, RI (US)

Correspondence Address: FOR: TYCO FIRE SUPPRESSION & BUILDING PRODUCTS;PERKINS COIE LLP, 607 Fourteenth Street, NW, Washington, DC, 20005-2003, US

(21) Appl. No.: 12/515,728

(22) PCT Filed: Dec. 7, 2007
(86) PCT No.: PCT/US07/86842

§ 371 Date: Dec. 3, 2009

Related U.S. Application Data
(60) Provisional application No. 60/869,194, filed on Dec. 8, 2006.

(51) Int. Cl. F16L 17/00; B23P 11/00

(52) U.S. Cl. 285/112; 285/373; 29/428

(57) ABSTRACT

A pipe coupling and gasket, a pipe coupling system, and installation method for joining and sealing adjoining pipes having different outer diameters. The gasket including three flanges extending radially inward, with the middle flange acting as a fulcrum against the outer surface of the larger pipe to cause distension of the opening of the gasket receiving the smaller pipe, to permit easy entry of the smaller pipe into the gasket. The gasket is then slid over the larger pipe so that the middle flange slips over the edge of the larger pipe to relax the opening of the gasket receiving the smaller pipe. The middle flange can also form a sealing surface on the outer diameter surfaces of the larger pipe or on both the larger and smaller pipes. The middle flange can also form a sealing surface against the radially extending end surface of the larger pipe.

### PRIORITY DATA AND INCORPORATION BY REFERENCE

This application claims the benefit of priority under 35 U.S.C. 119(e) to U.S. Provisional Patent Application No. 60/869,194, filed Dec. 8, 2006, which is incorporated by reference in its entirety.

### TECHNICAL FIELD

The subject invention relates to piping systems and, more particularly, to couplings and gaskets joining components of piping systems.

### BACKGROUND ART

Pipe coupling gaskets are commonly used with pipe couplings to seal adjoining pipes, with each end of the coupling-gasket assembly sized to fit to the end of each pipe. Typical designs of pipe coupling gaskets have a U-shaped cross section with a wall and two ends extending inwardly from the wall to form gasket ends that, when installed, fit over each end of two adjoining pipes with an interference fit, i.e., the inner diameters of the openings in the ends of the gasket are naturally smaller than the outer diameters of the pipes. The interference fit between the pipes and gasket requires the pipes to be forced into the ends of the gasket, with the gasket expanding to accommodate the pipe. When pipes of different sizes are joined together, the ends of the pipe coupling and gasket are typically sized to correspond to the ends of the respective pipes.

Typical coupling-gasket assemblies accommodate differently-sized pipes by having the larger pipe end of the coupling-gasket assembly fit over the larger pipe in the manner used with equal-sized pipes. However, the smaller pipe end of the coupling-gasket assembly must extend inwardly a greater distance from the wall than at the larger pipe end. For the coupling, which is typically made of a Ductile Iron, the extension is sufficiently strong to firmly engage the end of the smaller-sized pipe. However, for the gasket, which is typically made of an polymer, the extension is substantial and may result in a weaker gasket structure that is more susceptible to failure from forces generated by internal pressures within the pipes. Typically, this weaker side of the gasket is reinforced with stiffening struts formed within the gasket extension, but the formation of such struts results in a bulkier and less flexible gasket.

The assembly of two adjoining pipes with a gasket and coupling is typically done by the installer while on a ladder or in a dangerous position that requires the installer to use one hand to hold himself or herself in position, and the other to perform the operation. When installing a coupling-gasket assembly to equal-sized pipes, a typical procedure involves sliding one end of the gasket over an end of one of the pipes, inserting an end of the other pipe through the other end of the gasket, and then moving the gasket into the proper position on the ends of both pipes before installing the coupling. However, when joining two differently-sized pipes, the same sliding operation cannot be used with a gasket having differently-sized ends. If the large end of the gasket is placed on the large pipe first, the entry of the small pipe into the small end of the gasket is impeded because of the interference fit, and the extension between the wall and the opening at the smaller end of the gasket distorts the wall and causes the larger end of the gasket to slip off of the large pipe. The distortion of the wall of the gasket is typically greater when the small end of the gasket includes stiffening struts or is otherwise less resilient than the large end of the gasket. Because the typical sliding operation is not available or leads to the slipping of the large end of the gasket from the large pipe, the installer must move the gasket back on to the large pipe by holding the gasket in position with one hand while positioning the two pipes into proper positions within the gasket, which increases the risk of fall or injury to the installer because both hands are required for the installation. Furthermore, a second installer may be required to position the gasket and pipes appropriately, which results in increased installation costs.

Thus, what is needed is a gasket or a coupling-gasket assembly for joining two differently-sized pipes that permits single-handed assembly of the gasket, coupling, and pipes, and that requires only a single installer.

### DISCLOSURE OF INVENTION

The transition coupling of the preferred embodiment joins two pipes having different outer diameters. The coupling includes a gasket that functions as a seal by providing three axially-aligned flanges that extend inwardly from a gasket wall to form a triple seal. The flanges at each end of the gasket form separate seals against each of the pipes, and the middle flange forms a seal against the outer diameter surfaces of one or both of the pipes. The gasket facilitates the assembly of the pipes with the middle flange, which has a stepped structure that can be fitted entirely over the outer diameter surface of the larger pipe to form a seal on the larger pipe, and which places the gasket in a first distended state that causes the distension of the gasket at the end facing the smaller pipe. The distended gasket facilitates the insertion of the smaller pipe into the gasket. Once the smaller pipe is in place, the stepped structure of the middle flange is moved over the end of the larger pipe so that the gasket assumes a second distended state that causes the distended end of the gasket to partly relax and seal against the smaller pipe. The gasket also provides for a method of joining the pipes in which the middle gasket is fitted over the larger pipe to form a seal and to cause a first distended state in the gasket, the smaller pipe is inserted into the distended gasket, and the gasket is moved to cause a second distended state that forms a seal on the smaller pipe.

In one embodiment, the gasket has a circumferential wall defining a central axis, with the wall having axially opposing open ends and defining at least one channel on an inner side of the wall. A first flange is disposed at one of the opposing ends, a second flange is disposed at the other of the opposing ends, and a circumferential third flange is disposed between the first and second flanges. The third flange has first and second portions extending towards the axis, an end of the first portion is a first distance from the axis and an end of the second portion is a second distance from the axis, and the second distance is less than the first distance. The first portion can have a first pipe sealing surface and the second portion can have a second pipe sealing surface. The first portion can also have a first pipe sealing surface area and the second portion can have a second pipe sealing surface area, with the first pipe sealing surface being greater than the second pipe sealing surface area. The first and second portions each can have a circumferential inner side, with a radial side joining the inner sides, and the radial side and at least one of the inner sides can be a sealing surface. The gasket can have a first distended state in which an inner diameter of the second portion is equal to an inner diameter of the second flange, and a second distended state in which the inner diameter of the second portion is equal to or greater than an inner diameter of the first flange.

In another embodiment, the gasket has a circumferential wall defining a central axis, with the wall having axially opposing open ends and defining at least one channel on an inner side of the wall. The gasket also has at least three flanges extending from the wall towards the axis, with one of the at least three flanges being a circumferential flange disposed between two of the at least three flanges, and the one of the at least three flanges having first and second sealing surface areas with the first sealing surface area being greater than the second sealing surface area. The first and second sealing surface areas can each define a cone centered on the central axis. The first sealing surface area can have a longitudinal portion and a radial portion to the central axis, with the second sealing surface area having a longitudinal portion. The first and second sealing surface areas can be joined by a radial surface area. The first sealing surface area can extend longitudinally along the central axis, and the second sealing surface area can extend radially from the central axis. The gasket can also have a first distended state in which an inner diameter of the second sealing surface area is equal to an inner diameter of one of the two flanges, and a second distended state in which the inner diameter of the second sealing surface area is equal to or greater than an inner diameter of the other one of the two flanges.

In yet another embodiment, a pipe coupling system has a first pipe with an end and an outer diameter with the first pipe having an outer diameter surface at an outer periphery of the first pipe, a second pipe with an end and an outer diameter and with the second pipe end proximate to the first pipe end and the second pipe outer diameter being less than the first pipe outer diameter, a collar defining a central axis and having an outer axially-extending and axially-split circumferential wall with at least one pair of adjoining ends at the spilt and one end of the collar engaging the first pipe end and another end of the collar engaging the second pipe end, and at least one fastener releasably securing together the at least one pair of adjoining ends of the collar. The pipe coupling system also has a gasket having a circumferential wall positioned in the collar and having an exposed circumferential inner side exposed in the collar and facing the ends of the first and second pipes, with the inner side having at least three flanges extending from the wall towards the axis. One of the at least three flanges has a circumferential flange disposed between two of the at least three flanges, with the one of the at least three flanges having a first sealing surface and an adjacent sealing surface disposed adjacent to the first sealing surface, the adjacent sealing surface defining a surface that is approximately orthogonal to the central axis, and the first sealing surface sealing against the outer diameter surface of the first pipe and the adjacent sealing surface sealing against an end surface of the first pipe approximately orthogonal to the central axis. The gasket can also have a first distended state in which an inner diameter of the second sealing surface is equal to an inner diameter of one of the two flanges, and a second distended state in which the inner diameter of the second sealing surface is equal to or greater than an inner diameter of the other one of the two flanges.

In one method of sealing adjoining first and second pipes where the first pipe has an outer diameter that is greater than an outer diameter of the second pipe, the method involves positioning a flange extending from a gasket, with the flange abutting outside diameter surfaces of the first and second pipes. The method can include having the flange abutting a radially extending end surface of one of the first and second pipes.

In another method sealing adjoining first and second pipes where the first pipe has an outer diameter that is greater than an outer diameter of the second pipe, the method includes inserting an end of the first pipe through at least adjacent first and second flanges of a pipe coupling gasket, with the flanges extending from a wall of the gasket towards a central axis defined by the gasket, and with the second flange being a circumferential flange. The method further includes inserting an end of the second pipe through a third flange of the gasket extending towards the axis, moving the gasket over the first pipe towards the second pipe, and positioning the ends of the first and second pipes within an inner circumferential surface of the second flange. The method can also have the positioning of the ends of the first and second pipes include positioning a radially extending end surface of one of the first and second pipes to abut the second flange. The method can also have the positioning of the ends include positioning a middle sealing surface of the second flange over the ends of the first and second pipes. The method can also have the inserting of an end of the first pipe include inserting the end of the first pipe to extend thorough the pipe coupling gasket, and further include positioning the end of the second pipe proximate the end of the first pipe, and moving the pipe coupling gasket over the first pipe to allow the insertion of the end of the second pipe through the third flange.

In a method of connecting first and second pipes where the first pipe has an outer diameter that is greater than an outer diameter of the second pipe, the method includes positioning a gasket flange extending from a coupling, with the gasket flange abutting outside diameter surfaces of the first and second pipes, and locking the coupling to connect ends of the first and second pipes. The method can also have the positioning of the gasket flange include positioning the flange against a radially extending end surface of one of the first and second pipes.

In another method of connecting first and second pipes where the first pipe has an outer diameter that is greater than an outer diameter of the second pipe, the method includes inserting an end of the first pipe through adjacent first and second flanges of a pipe coupling, with the flanges extending from a wall of the coupling towards a central axis defined by the coupling and with the second flange being a circumferential flange. The method also includes inserting an end of the second pipe through a third flange of the coupling extending towards the axis, moving the coupling over the first pipe towards the second pipe, and positioning the ends of the first and second pipes within an inner circumferential surface of the second flange. The method can also have the positioning of the ends of the first and second pipes include positioning a radially extending end surface of one of the first and second pipes to the second flange. The method can also have the positioning of the ends include positioning a middle sealing surface of the second flange over the ends of the first and second pipes.

In yet another method of sealing adjoining first and second pipes where the first pipe has an outer diameter that is greater than an outer diameter of the second pipe, the method includes positioning over an end of the first pipe a first flange of a pipe coupling gasket extending towards a central axis defined by the gasket and compressing against the end of the first pipe. The method also includes positioning over an end of the second pipe a second flange of the pipe coupling gasket extending towards the axis and compressing against the end of the second pipe, and positioning over the ends of the first and second pipes a circumferential third flange of the pipe coupling gasket extending towards the axis with one portion of the third flange compressing against an outer diameter surface of the end of the first pipe and another portion of the third flange compressing against an outer diameter surface of the end of the second pipe. The method can also have the positioning of the third flange include positioning the third flange against a radially extending end surface of one of the first and second pipes.

### BRIEF DESCRIPTION OF THE DRAWINGS

The accompanying drawings, which are incorporated herein and constitute part of this specification, illustrate exemplary embodiments of the invention, and, together with the general description given above and the detailed description given below, serve to explain the features of the invention. In the drawings:

FIG. 1 is an orthogonal view of a gasket and coupling joining two pipes of dissimilar outer diameters;

FIG. 2 is an orthogonal cross sectional view of the gasket of the preferred embodiment and two pipes of dissimilar outer diameters;

FIG. 3 is an plan view of the coupling of the preferred embodiment;

FIG. 4 is a cross section partial plan view of the gasket of the preferred embodiment;

FIG. 5 is a cross section partial plan view of the gasket of an alternative embodiment;

FIGS. 6-9 are cross sectional plan views of the preferred installation procedure of the preferred embodiment;

FIGS. 10-13 are cross sectional plan views of an installation procedure of the alternative embodiment; and

FIGS. 14-16 are cross sectional plan views of the installation procedure of a prior art gasket.

### MODE(S) FOR CARRYING OUT THE INVENTION

The transition coupling of the preferred embodiment includes a gasket and coupling that joins together an end of a pipe with a relatively large outer diameter to an end of a pipe with a relatively small outer diameter. The gasket provides a seal between the two differently-sized pipes, and provides a structure for distending an end of the gasket to facilitate the insertion of the smaller pipe into the gasket during assembly. The gasket also provides for a preferred method of joining the pipes that involves distending one end of the gasket to permit insertion of the smaller pipe into the gasket.

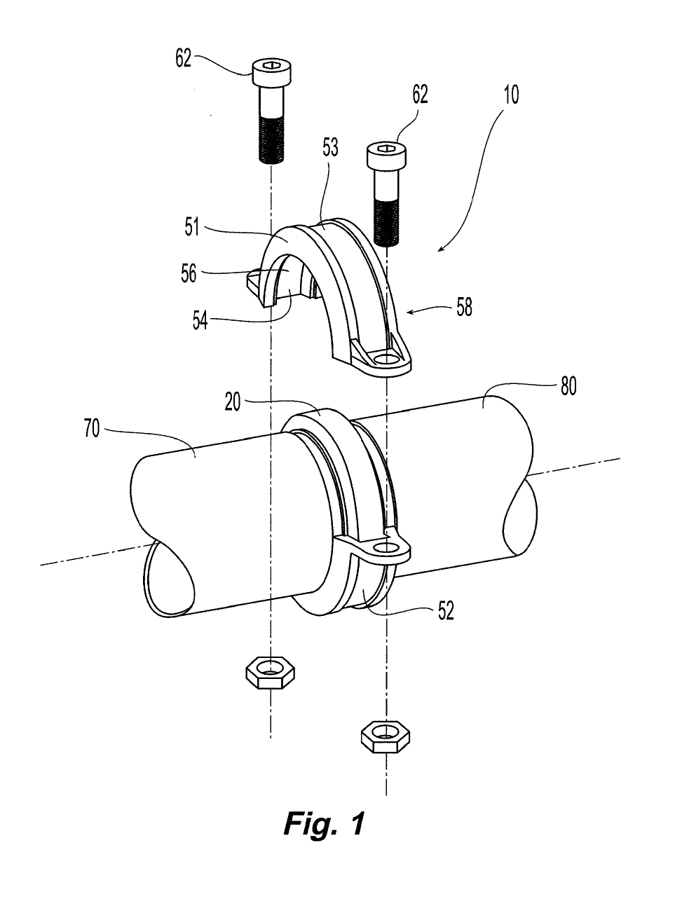

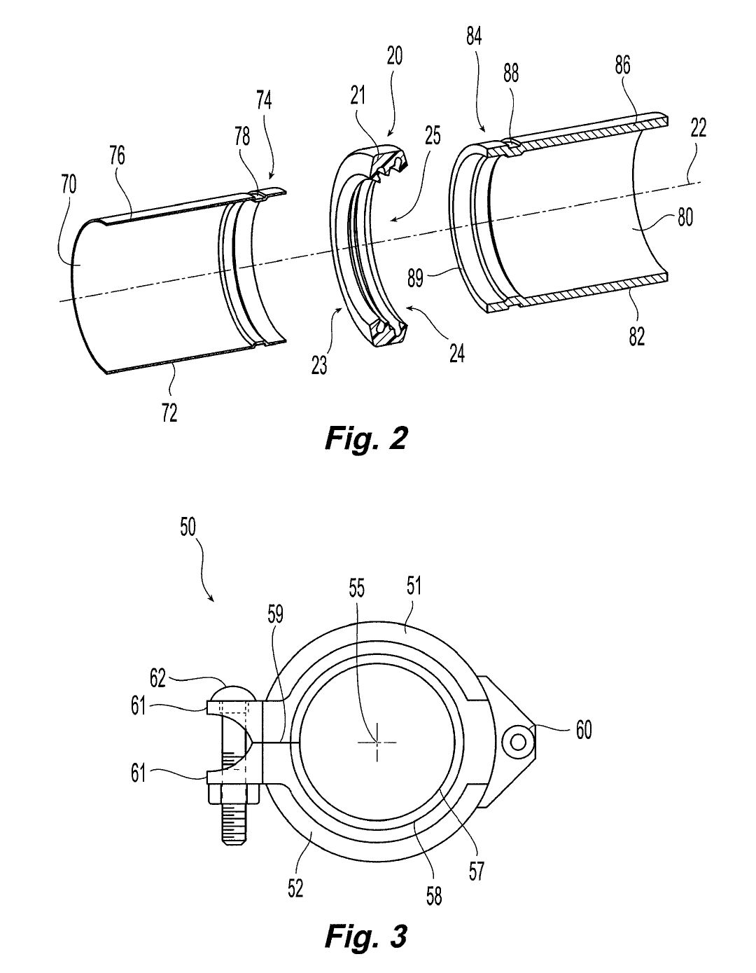

As illustrated in FIG. 1, a transition coupling 10 preferably includes a gasket 20 and a coupling 50, which join together a small diameter pipe 70 and a large diameter pipe 80. As illustrated in FIG. 2, the gasket 20 has a circumferential wall 21 that defines a central axis 22 and a small open end 23 and a large open end 24, and a channel 25 between the open ends 23 and 24.

The coupling secures and compresses the gasket against the ends of the differently-sized pipes, and securely engages the ends of each pipe. The coupling 50, illustrated in FIGS. 1 and 3, includes a top collar 51, a bottom collar 52, a circumferential wall 53, a channel 54, a central axis 55, an inner side 56, a small open end 57, a large open end 58, a split 59, adjoining ends 61, and a fastener 62, and preferably includes a hinge 60 as illustrated in FIG. 3. Additional details regarding the coupling can be found in U.S. Pat. No. 6,533,333 to Radzik, incorporated by reference herein in its entirety. As shown in FIG. 1, the coupling 50 can also be a two-piece design without the hinge 60 illustrated in FIG. 3. As also illustrated in FIG. 1, the coupling 50 is placed around the gasket 20 and secured in place with fasteners 62, so that the small open end 57 engages the small diameter pipe 70 and so that the large open end 58 engages the large diameter pipe 80. As illustrated in FIG. 2, the small diameter pipe 70 and the large diameter pipe 80 each have walls 72 and 82, ends 74 and 84, and outer diameter surfaces 76 and 86. The outer diameter surfaces 76 and 86 each include grooves 78 and 88 that engage the open ends 57 and 58 of the coupling 50, as illustrated in FIGS. 1 and 3.

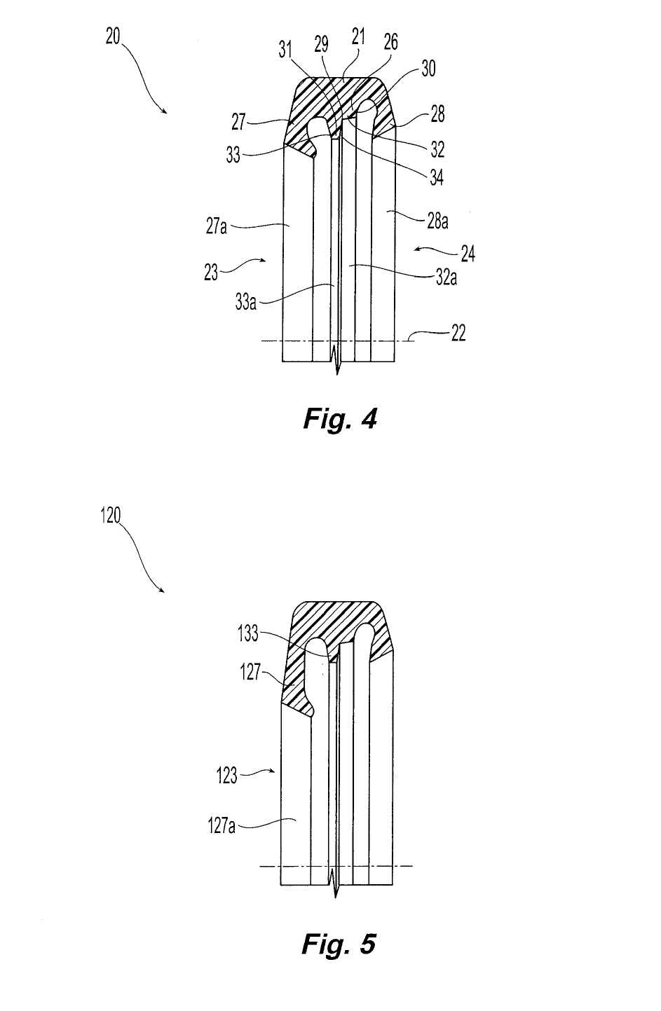

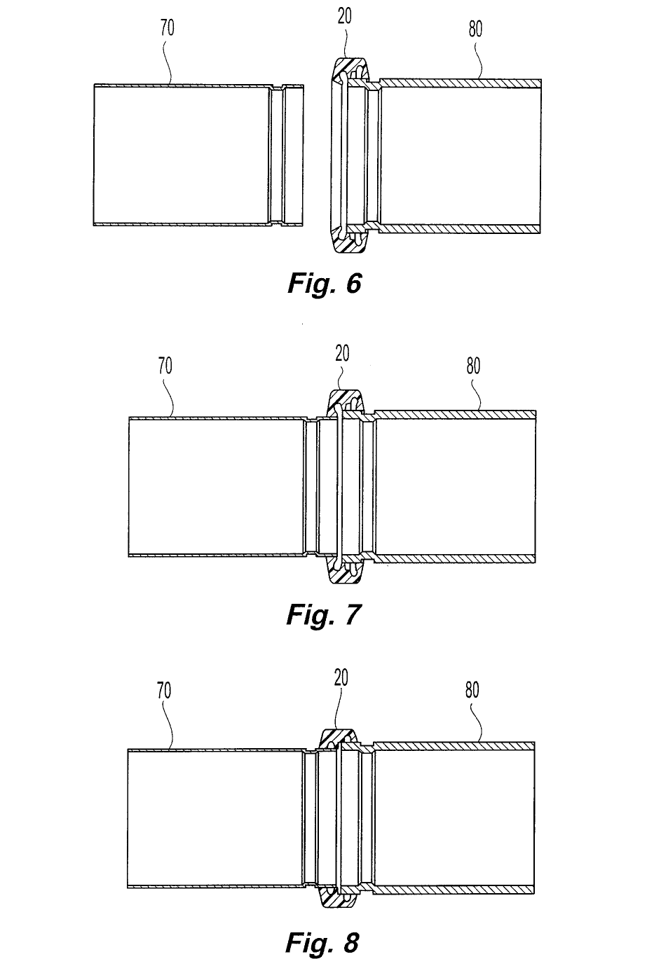

As illustrated in FIG. 4, the gasket 20 preferably includes an inner side 26 of the circumferential wall 21 from which extend a first flange 27, a second flange 28, and a middle flange 29. The first flange 27 forms the small open end 23, which has an inner diameter that is less than the outer diameter of the small diameter pipe 70, and is sized to form a seal when surface 27a is compressed against the outer diameter surface 76 of the small diameter pipe 70. The second flange 28 forms the large open end 24, which has an inner diameter that is less than the outer diameter of the large diameter pipe 80, and is sized to form a seal when surface 28a is compressed against the outer diameter surface 86 of the large diameter pipe 80. In the uncompressed state illustrated in FIG. 4, the surfaces 27a and 28a assume angled orientations in the longitudinal direction relative to the central axis 21 and, when compressed against the outer diameter surfaces 76 and 86 of the small and large diameter pipes 70 and 80 as illustrated in FIGS. 6-9, the surfaces 27a and 28a assume orientations that conform with the outer diameter surfaces 76 and 86. The compression of the surfaces 27a and 28a against the small and large diameter pipes 70 and 80 create sealing surfaces.

The middle flange preferably provides a stepped structure that simultaneously engages the ends of both pipes, as illustrated in FIG. 8. As illustrated in FIG. 4, the middle flange 29 includes a first portion 30 and a second portion 31 extending from the wall 21 towards the central axis 22. The second portion 31 extends farther from the wall 21 and towards the central axis 22 than the first portion 30, placing a second portion end 33 closer to the central axis 22 than a first portion end 32. The first portion end 32 has a first portion surface 32a, and the second portion end 33 has a second portion surface 33a. Between the first portion surface 32a and the second portion surface 33a is a joining surface 34 that extends in approximately a radial direction to the central axis 22 and connects the first and second portion surfaces 32a and 33a together to form a continuous stepped surface. In the uncompressed state, the first and second portion surfaces 32a and 33a assume angled orientations in the longitudinal direction relative to the central axis 22 and, when compressed against the outer diameter surfaces 76 and 86 of the small and large diameter pipes 70 and 80, the surfaces 32a and 33a assume orientations that conform with the outer diameter surfaces 76 and 86. The compression of the first and second portion surfaces 32a and 33a against the small and large diameter pipes 70 and 80 create sealing surfaces. Also, the compression of the joining surface 34 against the edge 89 of the large diameter pipe 80 creates a sealing surface.

The stepped structure of the middle flange also functions as a fulcrum that causes the smaller-sized open end of the gasket to assume a first distended state that allows insertion of the small diameter pipe into the gasket. As illustrated in FIG. 4, the gasket 20 naturally assumes a relatively non-stressed state where the first flange 27 and second flange 28 assume a relatively relaxed form with surfaces 27a and 28a each disposed at an angle in relation to the central axis 22 and outlining cone shapes opening away from the middle flange 29. Similarly, in the non-stressed state the middle flange 29 assumes a relaxed form with surfaces 32a and 33a each disposed at an angle in relation to the central axis 22 and outlining cone shapes opening away from the middle flange 29.

As illustrated in FIGS. 6-8, when the second flange 28 and middle flange 29 are preferably slid over the end 84 of the large diameter pipe 80, the second flange 28 and middle flange 29 are compressed outwardly from the central axis 22 because the outer diameter of the large diameter pipe 80 is greater than the inner diameters of the second flange 28 and the middle flange 29. Because of the stepped structure of the middle flange 29, the second portion 31 is subjected to greater compression than the first portion 30. The circumferential wall 21 reacts to the static forces generated by the differing compressions in the middle flange 29, and to the shape formed by the surfaces 32a, 33a, and 34, and causes the gasket 20 to deform into a first distended state so that the first flange 27 is circumferentially distended away from the central axis 22 to enlarge the diameter of the small open end 23 to be approximately equal to or larger than the outer diameter of the small diameter pipe 70. Once the gasket 20 is in the first distended state, the end 74 of the small diameter pipe 70 is inserted into the small open end 23, as illustrated in FIGS. 6-7. The amount of force required to insert the end 74 of the small diameter pipe 70 into the gasket 20 while in the first distended state is less than the amount of force that is required when the gasket 20 is in its non-stressed state.

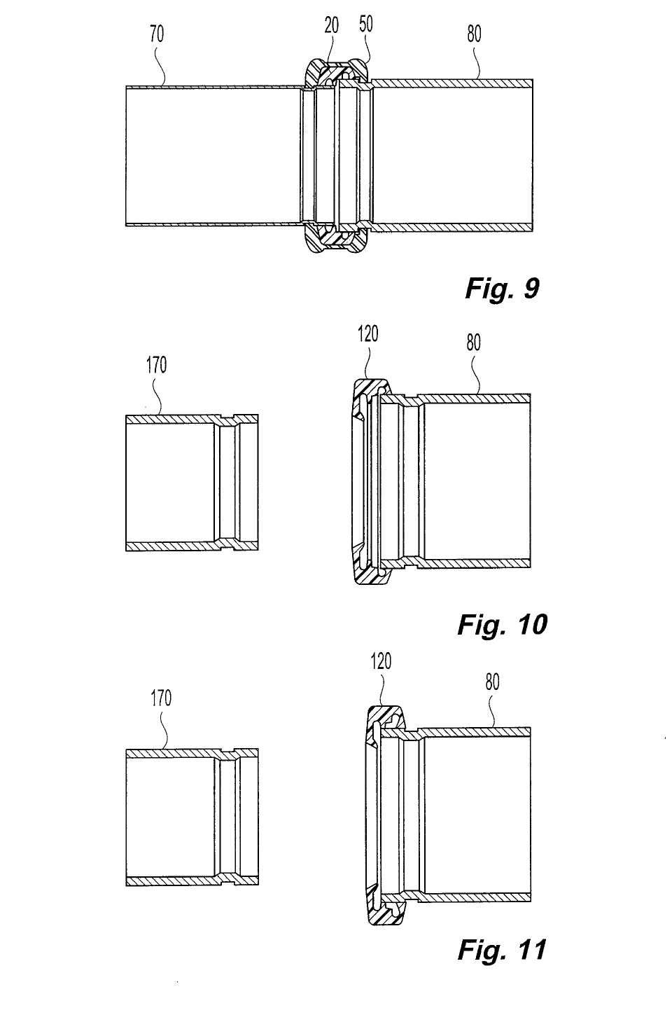

After the end 74 of the small diameter pipe 70 is properly placed within the small open end 23, the gasket 20 is moved over the large diameter pipe 80 towards the small diameter pipe 70 so that the stepped structure of the middle flange 29 is disposed proximate the space between the ends 74 and 84 of the pipes 70 and 80. As illustrated in FIGS. 7 and 8, the middle flange 29 is moved over the large diameter pipe 80 until the second portion surface 33a slips off of the large diameter pipe 80. When the second portion surface 33a slips off the large diameter pipe 80, the second portion surface 33a engages the outer diameter surface 76 of the small diameter pipe 70, and the first portion surface 32a moves to engage the outer diameter surface 86 of the large diameter pipe 80. The joining surface 34 also moves to engage the edge 89 of the large diameter pipe 80. The static compression forces in the middle flange 29 that cause the first distended state are partially relaxed when the second portion surface 33a slips off of the large diameter pipe 80, and the gasket 20 deforms into a second distended state in which the first flange 27 is compressed against the small diameter pipe 70, the second flange 28 is compressed against the large diameter pipe 80, and the middle flange 29 is compressed against both pipes 70 and 80. The coupling 50 is then installed around the gasket 20 to engage pipes 70 and 80, as illustrated in FIG. 9.

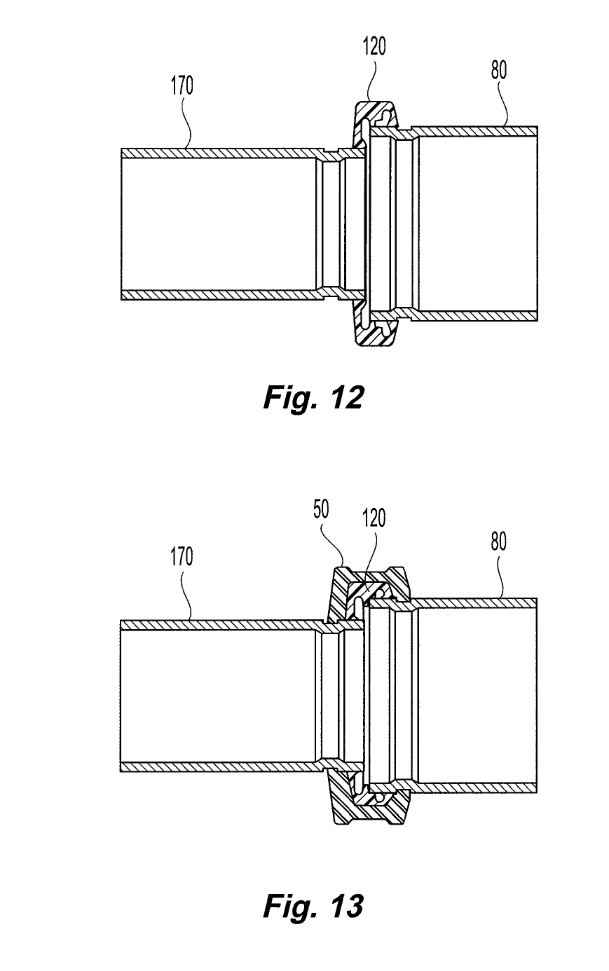

The preferred embodiment of FIG. 4 is again illustrated in FIG. 5 as an alternative embodiment, modified slightly to accommodate a greater difference between the outer diameter sizes of the adjoining pipes. As illustrated in FIG. 5, and in FIGS. 10-13, the first flange 127 of the gasket 120 forms the small open end 123 that has an inner diameter that is less than the outer diameter of a mating small diameter pipe 170, and is sized to form a seal when surface 127a is compressed against the outer diameter surface of the small diameter pipe 170. However, the second portion end 133 does not extend sufficiently inward to engage the small diameter pipe 170, and thus functions only as a fulcrum and not as a seal against the small diameter pipe 170. The description of FIGS. 4 and 6-9 otherwise applies entirely to the embodiment illustrated in FIGS. 5 and 10-13, and identical features are not identified again.

The gasket 20 can have ends 23 and 24 that accommodate a variety of sizes of pipes 70 and 80, with the middle flange 29 extending from the wall 21 to abut both pipes 70 and 80 or only pipe 80, depending on the degree of difference between the outer diameters of pipes 70 and 80 and the design characteristics required of the gasket 20. As can be appreciated when comparing FIGS. 4 and 5, the second portion surface 33a will not function as a seal when the outer diameter of the small diameter pipe 70 becomes too small to properly engage the second portion surface 33a. As can also be appreciated, if the second portion 31 is extended towards the central axis 22 too far, the second portion 31 will no longer form a diameter that can fit over the exterior of the large pipe 80 and will not function as a fulcrum. Whether the second portion 31 functions as a seal and fulcrum, or only as a seal or fulcrum, depends on the shape of the middle flange 29 and the material of the gasket 20. Preferably, the second portion 31 is made of a resilient material that will extend to fit over the large diameter pipe 80 and, when slipped off of the large diameter pipe 80, reduce to an inner diameter that will form a seal with the small diameter pipe 70. More preferably, the second portion 31 is made of ethylene propylene diene monomer (EPDM) nitrile or Buna N, fluoroelastomer silicone, or any elastomer with durometers ranging from 50-70 Shore A and forms an inner diameter that is expandable from a non-stressed state by 2-15% to fit over the large diameter pipe 80 and form a seal with the small diameter pipe 70. Most preferably, the second portion 31 is made of EPDM and forms an inner diameter that is expandable from a non-stressed state by 2-5% to fit over the large diameter pipe 80 and form a seal with the small diameter pipe 70.

Over a range of sizes of pipes 70 and 80, the transition from the design of the preferred embodiment, in which the middle flange functions as a seal and fulcrum, to an alternative embodiment, in which the middle flange functions only as a fulcrum, is dependent on the degree of difference between the outer diameters of the pipes 70 and 80 and the material of the gasket 20. Preferably, when the gasket 20 is made of a resilient material, the preferred embodiment design is used in the design of gasket 20 when the outer diameter of small diameter pipe 70 is 52-93% of the outer diameter of the large diameter pipe 80. More preferably, when the gasket 20 is made of EPDM nitrile or Buna N, fluoroelastomer silicone, or any elastomer with durometers ranging from 50-75 Shore A, the preferred embodiment design is used in the design of gasket 20 when the outer diameter of small diameter pipe 70 is 76-93% of the outer diameter of the large diameter pipe 80. Most preferably, when the gasket 20 is made of EPDM, the preferred embodiment design is used in the design of the gasket 20 when the outer diameter of the small diameter pipe 70 is 76-93% of the outer diameter of the large diameter pipe 80.

More preferably, in the non-stressed state, the gasket 20 has dimensions in the ranges described in Table 1, for an exemplary 4″ IPS×4″ CTS gasket size.

TABLE 1

| Gasket Dimension | Range |
|---|---|
| outer diameter of wall 21 | 133-135 mm |
| inner diameter of flange 27 | 102-104 mm |
| inner diameter of flange 28 | 111-113 mm |
| inner diameter of flange 29 | 113-115 mm |

Although specific materials, dimensions, and characteristics are describe in the preferred embodiments, it is appreciated that alternative designs can achieve the same functions of the described components and structures. For example, to enhance the fulcrum characteristics of the middle flange 29 in the first distended state, the materials of the gasket 20 can be modified or selected to direct the static forces in the circumferential wall 21 and further distend the small open end 23. For example, the middle flange 29 and wall 21 could be made of a material that is less resilient than the material of the first flange 27, so that the compression of the second portion 31 against the large diameter pipe 80 causes greater static forces in the gasket 20, which deform wall 21 and distend the small open end 23 in the first distended state to a greater degree than would be achieved with the use of a uniform material. For example, the middle flange 29 and wall 21 can be made of a material having a stiffness of 50-75 Shore A durometer, such as with EPDM nitrile or Buna N, fluoroelastomer silicone, or any elastomer with durometers ranging from 50-75 Shore A, whereas the first flange 27 can be made of a material with a stiffness that is greater than 75 Shore A, such as EPDM nitrile or Buna N, fluoroelastomer silicone, or any elastomer with durometers ranging greater than 75 Shore A.

In another alternative, the coupling 50 can be a variety of couplings that partly or entirely enclose gasket 20 and secure the ends 74 and 84 of the pipes 70 and 80. For example, the coupling 50 could be a grooved end or plain end coupling made by the green sand or investment cast methods using ductile iron, stainless steel, copper, or aluminum.

In yet another alternative, the installation procedure can be modified from that illustrated in FIGS. 6-13. The gasket 20 can be first placed on the large diameter pipe 80 in its entirety so that the end of the large diameter pipe 80 extends through the large and small open ends 23 and 24. The end 74 of the small diameter pipe 70 is then positioned proximate to the end 84 of the large diameter pipe 80, and the gasket 20 is slid over the large diameter pipe 80 so that the surface 27a slips off of the large diameter pipe 80 onto the small diameter pipe 70, and so that the second portion surface 33a slips off of the large diameter pipe 80 to assume the orientation illustrated in FIGS. 8-9 and 12-13. In yet another alternative, the same alternative installation procedure is performed but with the gasket 20 first placed on the small diameter pipe 70 in its entirety, and then slid over the small diameter pipe 70 to be disposed over the end 84 of the large diameter pipe 80. In this alternative, the surface 28a and first portion surface 32a do not contact any pipe until slid over the end 84 of the large diameter pipe 80.

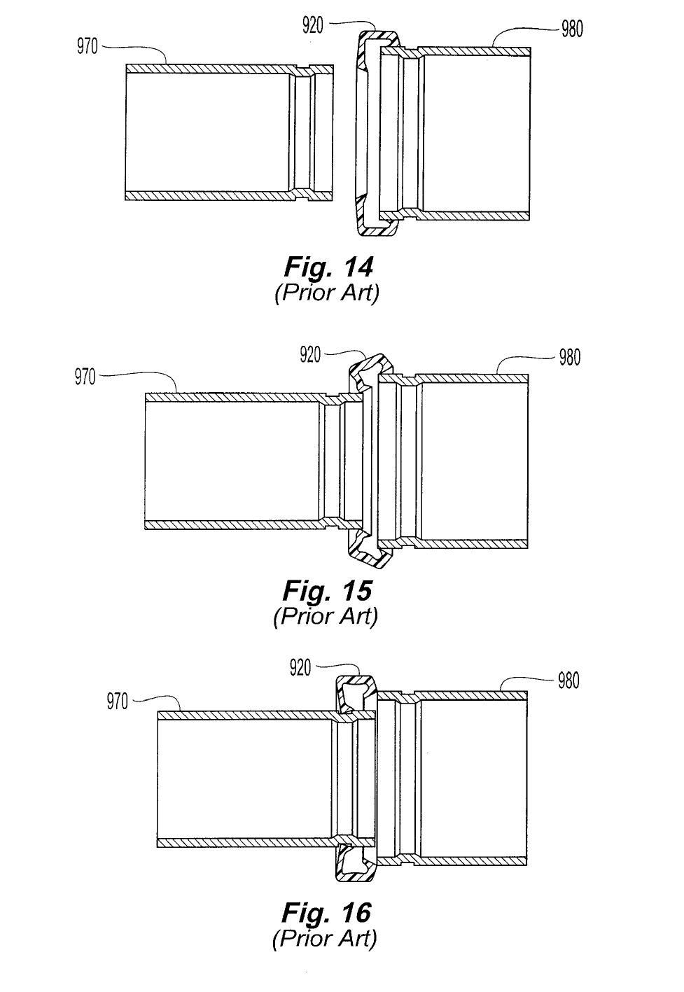

As described above and as illustrated in the drawings, the gaskets of the preferred and alternative embodiments thus address and overcome the problems with prior art gaskets used to join pipes of dissimilar diameters. Referring to FIGS. 14-16, when joining two differently-sized pipes with a prior art gasket, the large end of the gasket 920 is placed on the large pipe 980 first, and the entry of the small pipe 970 into the small end of the gasket 920 is impeded because of an interference fit between the small pipe 970 and the small end of the gasket 920. This interference fit causes the extension between the wall and the opening at the smaller end of the gasket 920 to distort the wall and also causes the larger end of the gasket 920 to slip off of the large pipe 980, as illustrated in FIGS. 14-16. The gaskets of the preferred and alternative embodiments do not slip off, as seen with prior art gaskets, because the distension of the small end of the gasket facilitates the entry of the small pipe into the gasket during installation. The stability of the gasket in the preferred and alternative installation methods allows the installation to be performed by one installer and with only a single hand, and does not necessitate multiple hands and installers as required with prior art gaskets.

While the present invention has been disclosed with reference to certain embodiments, numerous modifications, alterations, and changes to the described embodiments are possible without departing from the sphere and scope of the present invention, as defined in the appended claims. Accordingly, it is intended that the present invention not be limited to the described embodiments, but that it has the full scope defined by the language of the following claims, and equivalents thereof.

1. A pipe coupling gasket, comprising:
a circumferential wall defining a central axis, the wall having axially opposing open ends and defining at least one channel on an inner side of the wall;
a first flange disposed at one of the opposing ends;
a second flange disposed at the other of the opposing ends; and
a circumferential third flange disposed between the first and second flanges, the third flange having first and second portions extending towards the axis, an end of the first portion being a first distance from the axis and an end of the second portion being a second distance from the axis, the second distance being less than the first distance.

2. The pipe coupling gasket of claim 1, the first portion having a first pipe sealing surface and the second portion having a second pipe sealing surface.

3. The pipe coupling gasket of claim 1, the first portion having a first pipe sealing surface area and the second portion having a second pipe sealing surface area, the first pipe sealing surface being greater than the second pipe sealing surface area.

4. The pipe coupling gasket of claim 1, the first and second portions each having a circumferential inner side, a radial side joining the inner sides.

5. The pipe coupling gasket of claim 1, the first and second portions each having a circumferential inner side, a radial side joining the inner sides, the radial side and at least one of the inner sides being a sealing surface.

6. The pipe coupling gasket of claim 1, the gasket having a first distended state in which an inner diameter of the second portion is equal to an inner diameter of the second flange, and a second distended state in which the inner diameter of the second portion is equal to or greater than an inner diameter of the first flange.

7. A pipe coupling gasket, comprising:
a circumferential wall defining a central axis, the wall having axially opposing open ends and defining at least one channel on an inner side of the wall; and
at least three flanges extending from the wall towards the axis, one of the at least three flanges being a circumferential flange disposed between two of the at least three flanges, the one of the at least three flanges having first and second sealing surface areas with the first sealing surface area being greater than the second sealing surface area.

8. The pipe coupling gasket of claim 7, the first and second sealing surface areas each defining a cone centered on the central axis.

9. The pipe coupling gasket of claim 7, the first sealing surface area having a longitudinal portion and a radial portion to the central axis, the second sealing surface area having a longitudinal portion.

10. The pipe coupling gasket of claim 7, the first and second sealing surface areas joined by a radial surface area.

11. The pipe coupling gasket of claim 7, the first sealing surface area extending longitudinally along the central axis, the second sealing surface area extending radially from the central axis.

12. The pipe coupling gasket of claim 7, the gasket having a first distended state in which an inner diameter of the second sealing surface area is equal to an inner diameter of one of the two flanges, and a second distended state in which the inner diameter of the second sealing surface area is equal to or greater than an inner diameter of the other one of the two flanges.

13. A pipe coupling system, comprising:
a first pipe with an end and an outer diameter, the first pipe having an outer diameter surface at an outer periphery of the first pipe;
a second pipe with an end and an outer diameter, the second pipe end proximate to the first pipe end, the second pipe outer diameter being less than the first pipe outer diameter;
a collar defining a central axis and having an outer, axially extending, axially split circumferential wall with at least one pair of adjoining ends at the spilt, one end of the collar engaging the first pipe end and another end of the collar engaging the second pipe end;
at least one fastener releasably securing together the at least one pair of adjoining ends of the collar; and
a gasket having a circumferential wall positioned in the collar and having an exposed circumferential inner side exposed in the collar and facing the ends of the first and second pipes, the inner side having at least three flanges extending from the wall towards the axis, one of the at least three flanges being a circumferential flange disposed between two of the at least three flanges, the one of the at least three flanges having a first sealing surface and an adjacent sealing surface disposed adjacent to the first sealing surface, the adjacent sealing surface defining a surface that is approximately orthogonal to the central axis, the first sealing surface sealing against the outer diameter surface of the first pipe and the adjacent sealing surface sealing against an end surface of the first pipe approximately orthogonal to the central axis.

14. The pipe coupling system of claim 13, the gasket having a first distended state in which an inner diameter of the second sealing surface is equal to an inner diameter of one of the two flanges, and a second distended state in which the inner diameter of the second sealing surface is equal to or greater than an inner diameter of the other one of the two flanges.

15.-16. (canceled)

17. A method of sealing adjoining first and second pipes, the first pipe having an outer diameter greater than an outer diameter of the second pipe, comprising:
inserting an end of the first pipe through at least adjacent first and second flanges of a pipe coupling gasket, the flanges extending from a wall of the gasket towards a central axis defined by the gasket, the second flange being a circumferential flange;
inserting an end of the second pipe through a third flange of the gasket extending towards the axis;
moving the gasket over the first pipe towards the second pipe; and
positioning the ends of the first and second pipes within an inner circumferential surface of the second flange.

18. The method of claim 17, positioning the ends of the first and second pipes includes positioning a radially extending end surface of one of the first and second pipes to abut the second flange.

19. The method of claim 17, positioning the ends includes positioning a middle sealing surface of the second flange over the ends of the first and second pipes.

20. The method of claim 17, inserting an end of the first pipe includes inserting the end of the first pipe to extend thorough the pipe coupling gasket, and further includes positioning the end of the second pipe proximate the end of the first pipe, and moving the pipe coupling gasket over the first pipe to allow the insertion of the end of the second pipe through the third flange.

21. A method of connecting first and second pipes, the first pipe having an outer diameter greater than an outer diameter of the second pipe, comprising:
positioning a gasket flange extending from a coupling, the gasket flange abutting outside diameter surfaces of the first and second pipes; and
locking the coupling to connect ends of the first and second pipes.

22. The method of claim 21, positioning the gasket flange includes positioning the flange against a radially extending end surface of one of the first and second pipes.

23. A method of connecting first and second pipes, the first pipe having an outer diameter greater than an outer diameter of the second pipe, comprising:
inserting an end of the first pipe through adjacent first and second flanges of a pipe coupling, the flanges extending from a wall of the coupling towards a central axis defined by the coupling, the second flange being a circumferential flange;
inserting an end of the second pipe through a third flange of the coupling extending towards the axis;
moving the coupling over the first pipe towards the second pipe; and
positioning the ends of the first and second pipes within an inner circumferential surface of the second flange.

24. The method of claim 23, positioning the ends of the first and second pipes includes positioning a radially extending end surface of one of the first and second pipes to the second flange.

25. The method of claim 23, positioning the ends includes positioning a middle sealing surface of the second flange over the ends of the first and second pipes.

26. A method of sealing adjoining first and second pipes, the first pipe having an outer diameter greater than an outer diameter of the second pipe, comprising:
positioning over an end of the first pipe a first flange of a pipe coupling gasket extending towards a central axis defined by the gasket and compressing against the end of the first pipe;
positioning over an end of the second pipe a second flange of the pipe coupling gasket extending towards the axis and compressing against the end of the second pipe; and
positioning over the ends of the first and second pipes a circumferential third flange of the pipe coupling gasket extending towards the axis with one portion of the third flange compressing against an outer diameter surface of the end of the first pipe and another portion of the third flange compressing against an outer diameter surface of the end of the second pipe.

27. The method of claim 26, positioning the third flange includes positioning the third flange against a radially extending end surface of one of the first and second pipes.
